(19) United States
(12) Patent Application Publication
(10) Pub. No.: US 2026/0140223 A1
(43) Pub. Date: May 21, 2026

(54) OPTIMIZED VEHICLE-BORNE RADAR OPERATION BASED ON RETURN-SIGNAL CHARACTER

(71) Applicant: GPR, INC., Somerville, MA (US)

(72) Inventors: Amol Vagad, Westborough, MA (US); Eugene Klitenik, Watertown, MA (US); Pritpal Bains, Woburn, MA (US); Byron Stanley, Newton, MA (US)

(73) Assignee: GPR, INC., Somerville, MA (US)

(21) Appl. No.: 19/119,596

(22) PCT Filed: Oct. 13, 2023
(86) PCT No.: PCT/US2023/076833

§ 371 Date: Apr. 9, 2025

Related U.S. Application Data
(60) Provisional application No. 63/415,826, filed on Oct. 13, 2022.

(51) Int. Cl. G01S 7/292; G01S 7/03; G01S 7/282; G01S 13/88; G01S 13/931

(52) U.S. Cl. CPC G01S 7/2925; G01S 7/03; G01S 7/282; G01S 13/885; G01S 13/931

(57) ABSTRACT

A navigation system for a vehicle is disclosed, the system includes a radar antenna array and a radar operating system. The radar antenna array transmits and receives SPR Antenna radar signals, and includes a plurality of channels each including transmit and receive Array functionality. The radar operating system drives the antennas to emit radar signals and receives reflection signals at least partially from beneath the vehicle. The radar operating system (i) assess a complexity of signals received via each of the channels and, if the signal complexity associated with a channel falls below a threshold, reduces an operating parameter associated with that channel and (ii) periodically localizes the vehicle based at least in part on the received radar signals.

### CROSS-REFERENCE TO RELATED APPLICATIONS

This application claims the benefit of U.S. Provisional Patent Application No. 63/415,826 filed Oct. 13, 2022 entitled “Optimized Vehicle-Borne Radar Operation Based on Return-Signal Character”, which is incorporated by reference herein in its entirety.

### TECHNICAL FIELD

The present invention relates, generally, to the operation of vehicle-borne radar equipment used for, e.g., navigation, and more particularly to optimizing radar systems that localize position using radar reflections from the ground or other surface.

### SUMMARY

In certain embodiments, a navigation system for a vehicle may comprise: a radar antenna array configured to transmit and receive radar signals, the radar antenna array may comprise a plurality of channels each including transmit and receive functionality; and a radar operating system for driving the antennas to emit radar signals and receive reflection signals at least partially from beneath the vehicle. The radar operating system may be configured to (i) assess a complexity of signals received via each of the channels and, if the signal complexity associated with a channel falls below a threshold, reduce an operating parameter associated with that channel and (ii) periodically localize the vehicle based at least in part on the received radar signals.

In certain embodiments, a signal is identified as complex if it exhibits a signal-to-noise ratio (SNR) exceeding a threshold. In certain embodiments, the threshold is 20 dB. In certain embodiments, a channel signal is identified as complex if the signals received via all channels collectively contain more than a threshold number of unique features and the channel signal has features with a mean or peak value no more than a threshold level below the mean or peak value of the collective signal. In certain embodiments, the threshold level is 3 dB.

In certain embodiments, the operating parameter is a duty cycle. In certain embodiments, the duty cycle has a period determined at least in part by the signal complexity. In certain embodiments, the duty cycle has intervals of full power and no power whose relative durations are determined at least in part by the signal complexity. In certain embodiments, the radar operating system is configured to turn off a channel whose signal complexity falls below the threshold and periodically turn the channel back on to assess the signal complexity associated therewith. In certain embodiments, if the signal complexity associated with a channel is above the threshold, increasing an operating parameter associated with that channel.

In certain embodiments, a method of vehicle navigation may include the steps of: transmitting, with a radar antenna array comprising a plurality of channels, radar signals toward a travel surface and receiving radar signals reflected therefrom; computationally assessing, with a radar operating system, a complexity of the received radar signals via each of the channels and, if the signal complexity associated with a channel falls below a threshold, reducing an operating parameter associated with that channel; and periodically localizing the vehicle based at least in part on the received radar signals.

In certain embodiments, a signal is identified as complex if it exhibits a signal-to-noise ratio (SNR) exceeding a threshold. In certain embodiments, the threshold is 20 dB.

In certain embodiments, the method may further comprising the step of identifying unique features associated with the received radar signals from each channel and with a collective signal from all channels, wherein a channel signal is identified as complex if the received radar signals from all channels collectively contain more than a threshold number of unique features and the channel signal has features with a mean or peak value no more than a threshold level below the mean or peak value of the collective signal.

In certain embodiments, the step of identifying unique features is performed by feature extraction. In certain embodiments, the threshold level is 3 dB. In certain embodiments, the operating parameter is a duty cycle. In certain embodiments, the duty cycle has a period determined at least in part by the signal complexity. In certain embodiments, the duty cycle has intervals of full power and no power whose relative durations are determined at least in part by the signal complexity.

In certain embodiments, the radar operating system is configured to tum off a channel whose signal complexity falls below the threshold and periodically tum the channel back on to assess the signal complexity associated therewith. In certain embodiments, if the signal complexity associated with a channel is above a threshold, increasing an operating parameter associated with that channel.

### BRIEF DESCRIPTION OF THE DRAWINGS

The foregoing summary, as well as the following detailed description of embodiments of the system, will be better understood when read in conjunction with the appended drawings of an exemplary embodiment. It should be understood, however, that the invention is not limited to the precise arrangements and instrumentalities shown.

In the drawings:

FIG. 1 schematically depicts an exemplary surface penetrating radar (SPR) system in accordance with embodiments of the invention; and

FIG. 2 is a front view of a vehicle including the SPR system of FIG. 1.

### DETAILED DESCRIPTION

Vehicle navigation may be carried out using surface-penetrating radar (SPR). This approach provides precise vehicle positioning regardless of poor weather or visibility, faint road markings, or other common challenges facing advanced driver-assistance systems. SPR systems may localize a vehicle to within a few centimeters. A typical SPR navigation system includes an array of antenna elements, which may be directed downwardly toward the ground. Each antenna element includes transmit and receive capability and corresponds to a separate channel. The channels are operated independently, and the surface and subsurface information obtained from all channels are integrated into an SPR image used to localize the vehicle by, e.g., comparison to position-indexed reference SPR images.

In typical implementations, each channel continually transmits at full power during its part of the transmission cycle. This may not be efficient, since not all antenna elements contribute equally to the composite image; for example, the outer channels may not overlie ground regions that yield meaningful reflections. The result is excess power consumption as well as an unnecessary computational burden, since low-information signals are processed despite their minor contribution to the SPR image and localization.

Accordingly, there is a need for adaptive approaches to operation of vehicle SPR systems that tailor the power and computational resources allotted to individual SPR channels based their contributions to vehicle localization.

In accordance with embodiments of the present invention, received signal complexity is used as a criterion to determine the amount of power and/or computational resources devoted to operation of each channel in an SPR array. If, for example, the signal complexity is so low that the channel is not meaningfully contributing to vehicle localization, it may be powered off altogether (e.g., for a pre-set time).

The term “complex signal,” as used herein, means a signal satisfying a complexity threshold specified by an objective formula or function. For example, a complex signal may be one having a mean amplitude exceeding a noise floor or satisfying a minimum signal-to-noise ratio (SNR). If the signal contains significant spectral content that is unique in character, the complexity threshold may be set as, e.g., 3 dB below the mean or peak value in that spectral region. This is discussed in further detail below.

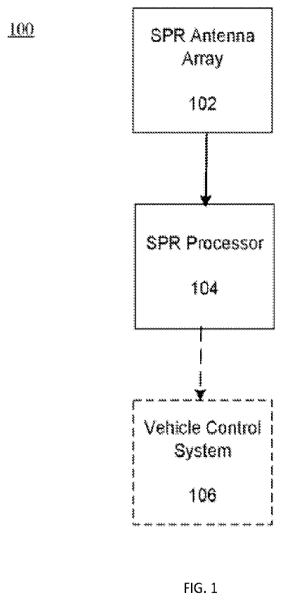

With reference to FIG. 1, a representative mobile SPR system 100 includes an SPR antenna array 102, which, as detailed below, may be mounted to the underside of a vehicle. The SPR antenna array 102 includes one or more antenna elements for transmitting and receiving radar signals. An SPR processor 104 controls the transmit operations of SPR antenna array 102, receives return radar signals for analysis, and monitors the return signals for complexity in controlling the SPR antenna array 102 as described below. In various embodiments, the detected SPR signals are processed to generate one or more SPR images of the surface and/or subsurface region along the track of the vehicle to which the antenna array 102 is mounted. Suitable SPR antenna configurations and systems for processing SPR signals are described, for example, in U.S. Pat. No. 8,949,024, the entire disclosure of which is hereby incorporated by reference.

For navigation, the SPR images are compared to SPR reference images that were previously acquired and stored for subsurface regions that at least partially overlap the subsurface regions for the defined route. The image comparison may be a registration process based on, for example, correlation; see, e.g., U.S. Pat. No. 8,786,485, the entire disclosure of which is incorporated by reference herein. The location of the vehicle and/or the terrain conditions of the route can then be determined based on the comparison.

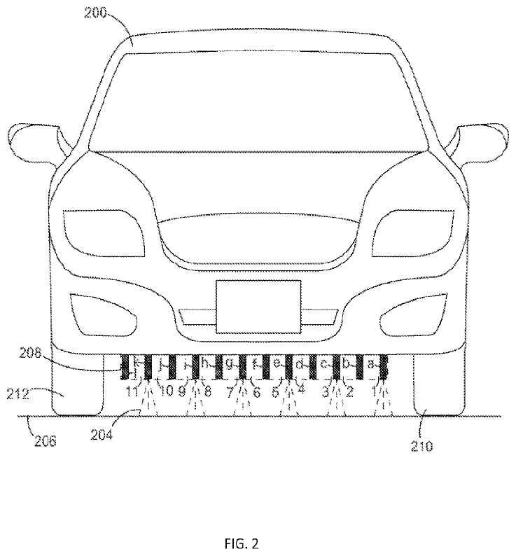

With reference to FIGS. 2A and 2B, a vehicle 200, which may be any mobile platform or structure, includes a SPR system 202 that transmits SPR signals 204 from a plurality of SPR transmit elements as shown in FIG. 2B. The antenna array 208 includes, illustratively, a linear configuration of 12 spatially invariant transmit and receive antenna elements a through 1 for transmitting and receiving radar signals. The twelve antenna elements may form eleven channels 1-11. Each channel includes a transmit and a receive element or a transmit and a receive pair. In some embodiments, antenna elements are also included on the front bumper of the vehicle 200 to detect guiding elements.

The SPR antenna array 208 may be nominally or substantially parallel to the ground surface 206 and may extend parallel or perpendicular to the direction of travel. SPR signals 204 propagate downward from the transmitting antenna elements to and/or through the road surface 206 under the vehicle 202. The SPR signals are backscattered upwardly from the surface 206 or subsurface of the road and are detected by the receiving antenna elements.

In accordance with various embodiments of the present invention, the SPR processor 104 continuously or periodically analyzes the return signals received via the channels 1-11 and assess them against a complexity criterion. If the criterion is satisfied, the transmit function is operated normally and the return signals are processed as described above. If the criterion is not satisfied, however, the SPR processor 104 may allocate less power and computational processing to a weak channel by altering its duty cycle, i.e., cycling the power on and off for fixed intervals. The absolute and relative durations of the on/off intervals may be determined by the degree of shortfall from the complexity threshold, e.g., the greater the shortfall, the higher the duration of the “off” state relative to the “on” state and/or the longer the cycle period will be. Alternatively, the distance between complexity criteria satisfaction points can be used to govern transition between on and off states. For example, the distance between points may be a function of speed. If the signal complexity associated with a channel is above the threshold, an operating parameter associated with that channel may be increased. The channels that are in the “on” state may have an increased scan rate when non-utilized channels are turned to the “off” state. Increasing the scan rate of each “on” channel can allow more data to be collected from the surface and/or subsurface regions. In some embodiments, a state machine handles transitions of the channels between on and off states.

In still other embodiments, channel power is proportionally reduced rather than cycled on and off. Overall power may be reduced, or the reduction may apply to specific frequencies or frequency bands. SPR signals 204 may propagate downward from the transmitting antenna elements to and/or through the road surface 206 under the vehicle 202 at a bandwidth of, for example, 100 Hertz when the vehicle 202 is stopped, and may increase to a bandwidth of 200 Hertz when the vehicle 202 is traveling at a maximum speed (e.g., 100 mph). In some embodiments, the bandwidth may change proportionally based on the speed of the vehicle 202 between 100-200 Hertz, between 110-190 Hertz, between 120-180 Hertz, between 130-170 Hertz, and between 140-160 Hertz. Increasing the bandwidth and shortening the interval can allow more data to be collected from the surface and/or subsurface regions.

As noted above, a complex signal may be one having a mean amplitude exceeding a noise floor or satisfying a minimum SNR. In decibels (dB), the SNR may be defined as 20 log₁₀ (signal amplitude/noise amplitude). The signal is the reflected return off an object or set of objects. The noise is the average background amplitude excluding the signal. For example, thermal noise at the receiver may be given by N=kTB, where N is the power in watts, k is Boltzmann's constant (1.38×10⁻²³ J/K), T is the absolute temperature in Kelvin and B is the emission bandwidth in Hertz. The minimum SNR may be, for example, 20 dB or higher.

As noted earlier, the threshold may alternatively be based on spectral content that is unique in character. Uniqueness in character may be assessed using a conventional feature-extraction algorithm (e.g., wavelet-based feature extraction, genetic algorithm-based frequency-domain feature search, etc.) to identify high-value features. If the number of high-value features in the map or in the current SPR image (or both) exceeds a minimum value, the complexity threshold may be set as a value (e.g., 3 dB) below the mean or peak of the high-value features. In the absence of a sufficient number of high-value features, the SNR criterion may be used or it may be decided that the overall signal lacks enough character to determine when any particular channel is contributing insufficiently.

Other suitable metrics include the coefficient of variation, dynamic range, and average power. The coefficient of variation is defined as the ratio of signal standard deviation to signal mean for each channel. The coefficient of variation of each channel should be within minimum/maximum thresholds established based on the expected operational domain and/or similarity to other channels e.g., thresholds may be set at one or two standard deviations from the mean value of all channels combined.

The dynamic range is defined as the ratio of largest signal value to smallest signal value for each channel. Average power is defined as the mean of the absolute values of the channel signals. These metrics also should also be within expected minimum/maximum thresholds (e.g., set at one or two standard deviations from the mean value of all channels combined) and/or near the expected similarity of other channels.

The SPR processor 104 may include one or more modules implemented in hardware, software, or a combination of both. For embodiments in which the functions are provided as one or more software programs, the programs may be written in any of a number of high-level languages such as PYTHON, FORTRAN, PASCAL, JAVA, C, C++, C #, BASIC, various scripting languages, and/or HTML. Additionally, the software can be implemented in an assembly language directed to the microprocessor resident on a target computer; for example, the software may be implemented in Intel 80x86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A navigation system for a vehicle, the system comprising:
a radar antenna array configured to transmit and receive radar signals, the radar antenna array comprising a plurality of channels each including transmit and receive functionality; and
a radar operating system for driving the antennas to emit radar signals and receive reflection signals at least partially from beneath the vehicle, the radar operating system being configured to (i) assess a complexity of signals received via each of the channels and, if a signal complexity associated with a channel falls below a threshold, reduce an operating parameter associated with that channel and (ii) periodically localize the vehicle based at least in part on the received radar signals.

2. The system of claim 1, wherein a signal is identified as complex if it exhibits a signal-to-noise ratio (SNR) exceeding a threshold.

3. The system of claim 2, wherein the threshold is 20 dB.

4. The system of claim 1, wherein a channel signal is identified as complex if the signals received via all channels collectively contain more than a threshold number of unique features and the channel signal has features with a mean or peak value no more than a threshold level below the mean or peak value of the collective signal.

5. The system of claim 4, wherein the threshold level is 3 dB.

6. The system of claim 1, wherein the operating parameter is a duty cycle.

7. The system of claim 6, wherein the duty cycle has a period determined at least in part by the signal complexity.

8. The system of claim 6, wherein the duty cycle has intervals of full power and no power whose relative durations are determined at least in part by the signal complexity.

9. The system of claim 1, wherein the radar operating system is configured to turn off a channel whose signal complexity falls below the threshold and periodically turn the channel back on to assess the signal complexity associated therewith.

10. The system of claim 1, wherein the radar operating system is further configured to increase an operating parameter associated with the channel when the signal complexity associated with the channel is above the threshold.

11. A method of vehicle navigation, the method comprising the steps of:
transmitting, with a radar antenna array comprising a plurality of channels, radar signals toward a travel surface and receiving radar signals reflected therefrom;
computationally assessing, with a radar operating system, a complexity of the received radar signals via each of the channels and, if the signal complexity associated with a channel falls below a threshold, reducing an operating parameter associated with that channel; and
periodically localizing the vehicle based at least in part on the received radar signals.

12. The method of claim 11, wherein a signal is identified as complex if it exhibits a signal-to-noise ratio (SNR) exceeding a threshold.

13. The method of claim 12, wherein the threshold is 20 dB.

14. The method of claim 11, further comprising the step of identifying unique features associated with the received radar signals from each channel and with a collective signal from all channels, wherein a channel signal is identified as complex if the received radar signals from all channels collectively contain more than a threshold number of unique features and the channel signal has features with a mean or peak value no more than a threshold level below the mean or peak value of the collective signal.

15. The method of claim 14, wherein the step of identifying unique features is performed by feature extraction.

16. The method of claim 14, wherein the threshold level is 3 dB.

17. The method of claim 11, wherein the operating parameter is a duty cycle.

18. The method of claim 17, wherein the duty cycle has a period determined at least in part by the signal complexity.

19. The method of claim 17, wherein the duty cycle has intervals of full power and no power whose relative durations are determined at least in part by the signal complexity.

20. The method of claim 11, wherein the radar operating system is configured to tum off a channel whose signal complexity falls below the threshold and periodically tum the channel back on to assess the signal complexity associated therewith.

21. The method of claim 11, further comprising: increasing the operating parameter associated with the channel if the signal complexity associated with the channel is above the threshold.
